(19) United States
(12) Patent Application Publication
(10) Pub. No.: US 2003/0180432 A1
(43) Pub. Date: Sep. 25, 2003

(54) Prepared soymilks and soymilk beverages

(76) Inventors: Takeo Shimizu, Kanagawa (JP); Yukie Nagai, Kanagawa (JP); Tadashi Ebashi, Kanagawa (JP)

Correspondence Address: Gerald Levy, Esq., PITNEY, HARDIN, KIPP & SZUCH LLP, 685 Third Avenue, New York, NY, 10017-4024, US

(21) Appl. No.: 10/359,768

(22) Filed: Feb. 6, 2003

(30) Foreign Application Priority Data
Feb. 8, 2002 (JP) 2002-32516

(51) Int. Cl. A23L 2/38

(52) U.S. Cl. 426/598

(57) ABSTRACT

Prepared soymilks and soymilk beverages which contain palatinose. The use of palatinose in soymilk compositions allows the preparation of prepared soymilks and soymilk beverages excellent in their light and smooth mouth feels and having a good aftertaste.

### FIELD OF INVENTION

The present invention relates to a soymilk composition with an improved flavor.

### BACKGROUND OF INVENTION

In recent years, the concern among consumers for their health has been rising and, as a result, natural foods and functional foods are enjoying great popularity. Among these, soymilk, made from soybeans, contains good-quality proteins and, further, the fats and oils contained therein, while being of vegetable nature and containing a high amount of linoleic acid, contain no cholesterol. Therefore, the consumption of soymilk as a natural functional food containing high amounts of vitamin E and lecithin originally rich in the starting material soybeans is increasing year by year. Furthermore, isoflavone, a constituent of soybeans, is attracting interest from the health food industry because it has physiological functions, such as the prevention of osteoporosis, the relief of the discomforting symptoms caused by menopausal disorders, and the prevention of arteriosclerosis. Namely, soymilk is a drink chosen by consumers due to their attaching greater importance to the functions than to the taste. However, soymilk has a drawback in the odor and acrid taste characteristically possessed by soybeans and, therefore, for those consumers who attach greater importance to taste rather than to functions, such a drawback presents an obstacle to further expanding the consumption of soymilk.

Said soybean odor is a result of the presence of substances, such as n-hexanol, n-hexanal and ethylvinyl ketone, and it is known that n-hexanol, which is the main cause of the odor, forms very soon when raw soybeans are broken, under the enzymatic action of, e.g., lipoxygenases present in the soybeans. It is further known that several phenolic acids are the source of said acrid taste. Such acrid taste of soymilk is also expressed as bitterness, astringency or others depending on the consumer and is a stimulating taste, slightly numbing to the mouth. It has been reported that among these phenolic acids, syringic acid, vanillic acid, ferulic acid and gentisic acid cause the astringency, and chlorogenic acid and isochlorogenic acid cause the bitterness.

For improving the flavor of soymilk, several methods were developed in the United States during the 1970s, wherein soybeans are ground under heating conditions, thereby deactivating lipoxygenases and preventing the formation of soybean odor components. These methods are called the “Cornell method”, “USDA method” and “Illinois method”, respectively, and are practically used in Japan by utilizing the respective features of these methods. Furthermore, other methods are also used, wherein, for the removal of the soybean odor which has already been formed, steam is introduced to distill off the soybean odor components, or the soybean odor is masked by means of flavor-imparting additives. For such a masking method, a deodorizing agent comprising a sugarcane extract as the active ingredient is suggested, which extract reduces the unpleasant odor characteristic of pulses and vegetables (JP 11155516A). Also suggested is the addition of the extract of campanulaceae plants to soymilk to improve its drinkability (JP60009462A).

Soymilk compositions with an improved taste available on the market are generally soymilk beverages to which various flavorings, sweeteners and other additives are added. Besides these, fermented soymilks, which are processed into yogurt-like products in order to improve the flavor and, at the same time, provide the functions to regulate intestines, are also marketed. However, in soymilk beverages which contain flavorings, cocoa, fruit juice, sweeteners or others, the respective tastes and aromas of these additives incorporated therein tend to excessively influence the taste of the end product, and the sweetness also tends to become excessive.

As described above, attempts have been made in order to improve the flavor of soymilk compositions, such as, as mentioned above, the grinding of soybeans under heating, or the addition of various flavorings or favor-improvers to soymilk compositions. In recent years, using these methods, the taste of soymilk compositions has been improved and the consumption thereof is dramatically increasing. However, for prepared soymilks which contain small amounts of other additional ingredients, the flavor-improving effect is not yet sufficient, though, small amounts of sweeteners and flavorings are added thereto in order to provide a smooth drinkability. Therefore, there is still room for improvement in terms of delicacy.

In recent times, the soymilk compositions mainly experiencing increased consumption are soymilk beverages, types of which, due to the thus expanded market, are appearing in greater number than ever before. Generally, in the soymilk beverages currently marketed, additives, such as sweeteners, cocoa and fruit juice, are incorporated in relatively high amounts so that the tastes derived from these additives are distinctly perceptible. In addition, strong flavorings are generally added. However, the addition of such various ingredients in relatively high amounts naturally reduces the amount of the soymilk-original components incorporated into the beverages. Therefore, there was a problem such that the soymilk content in the beverages decreased due to the content of said ingredients added in relatively high amounts in order to improve the taste, even though the main purpose of consumers in choosing soymilk compositions was essentially to utilize the useful components derived from soybeans, such as proteins and isoflavone. Furthermore, since soymilk beverages have relatively strong sweetness, and flavorings having a very strong aroma are added thereto in order to mask the unpleasant taste and odor of soymilk, the beverages are insufficient in lightness and good aftertaste preferred by many consumers.

In general, soymilk or soymilk compositions are regarded as drinks having the purpose of taking the various active components derived from soybeans or as substitutes for cow's milk for those people who cannot consume the latter due to lactose intolerance or milk allergy. Soymilk is also processed into fermented soymilks in order to improve the flavor of soymilk. However, fermented soymilks are given the function of regulating intestines by fermenting soymilk with various lactic acid bacteria, bifidobacterium or others and, thus, these are regarded as substitutes for fermented milks. Therefore, fermented soymilks belong to a category different from that of soymilks and, thus, cannot be essentially defined as soymilks with an improved taste.

As is shown from the above, there was a need for prepared soymilks and soymilk beverages, in which the unpleasant taste and odor characteristic of soymilk are improved and the taste is excellent in lightness and aftertaste.

### SUMMARY OF INVENTION

It has now been found that the addition of palatinose to prepared soymilks or soymilk beverages can reduce the unpleasant taste and odor derived from soybeans and provide prepared soymilks and soymilk beverages excellent in light taste and aftertaste.

The present invention, which is based on the above finding, relates to a prepared soymilk and soymilk beverage, the flavor of which being improved by the addition of palatinose.

### DETAILED DESCRIPTION OF PREFERRED EMBODIMENTS

Soymilk, which is the starting material for the prepared soymilk and soymilk beverage according to the present invention, can be made using any conventional method. For example, it can be made by soaking whole soybeans or defatted soybeans in water and then grinding these in the water or, alternatively, directly grinding such soybeans with the addition of water, to give a mash (so called “Go” in Japanese), then subjecting the mash to a further treatment, such as filtration, to remove the insoluble fractions contained therein.

The term “prepared soymilk” used herein is taken to mean a soymilk composition, conventionally called “prepared soymilk” or “blended soymilk”, in which only small amounts of sweeteners, vegetable oils, salts, stabilizers, spices or the like are added to the starting material soy milk and, thereby, the original taste of soymilk is utilized. The term “soymilk beverage” used herein is taken to mean a soymilk composition, conventionally called “soymilk beverage” or “soymilk drink”, in which various sweeteners, flavorings, fruit juice, cocoa, tea, coffee, malts, powdered green tea or the like are added to the starting material soymilk such that the tastes of these additives are distinctly perceivable on consumption.

Palatinose is also referred to as isomaltulose and is a disaccharide consisting of fructose and glucose linked to each other via a α-1,6-glucosyl linkage. The properties of palatinose hydrate crystal are as follows: melting point: 123 to 124° C.; specific rotation: [α]²⁰_{D}+97.2; reducing power on Fehling's solution: 52% relative to glucose; solubility in 100 g of water: 38.4 g at 20° C. and 174.9 g at 60° C. The quality of sweetness of the aqueous solution is good. The sweetness potency depends on the reference solution used for comparison and is about 40% relative to sucrose when compared with the sweetness potency of a 4.5% aqueous sucrose solution as the control.

In nature, palatinose is found in honey and sugarcane juice. It is also present in the rearrangement product formed from sucrose under the action of α-glucosyltransferases derived from bacteria or yeasts.

Palatinose is industrially made through the transformation of the majority of sucrose by bringing the sucrose under the action of α-glucosyltransferases produced by bacteria, such as Protaminobacter rubrum and Serratia plymuthica.

The palatinose used according to the present invention may be crystalline palatinose and palatinose syrup. Specifically, mention can be made of crystalline palatinose which contains at least 99.0% of palatinose and is in the form of a hydrous crystal (Trade name: Crystalline palatinose-IC, Shin Mitsui Sugar Co., Ltd.); palatinose syrup which contains 11 to 17% of palatinose (Trade name: Palatinose syrup-ISN or -TN, Shin Mitsui Sugar Co., Ltd.); and trehalulose syrup which contains 8 to 13% of palatinose (Trade name: Mildia MD-75 or -85, Shin Mitsui Sugar Co., Ltd.).

According to the present invention, by adding palatinose to soymilk, there is provided a prepared soymilk and soymilk beverage wherein the taste is improved by reducing the unpleasant taste and odor characteristic of soybeans, the aftertaste is excellent and light and smooth feels are imparted to the taste.

When adding palatinose to prepared soymilks, the amount of palatinose added is preferably 0.5 to 7% by weight, more preferably 0.5 to 5% by weight based on the finished palatinose-containing prepared soymilks. In this range of the amount of palatinose, the sweetness derived from palatinose is hardly perceivable and, therefore, the flavor of prepared soymilks can be improved by reducing the unpleasant taste and odor of soymilk while utilizing the original taste of the latter.

When adding palatinose to soymilk beverages, the amount of palatinose added is preferably 0.5 to 15% by weight, more preferably 0.5 to 10% by weight, based on the finished palatinose-containing soymilk beverages. In this range of the amount of palatinose, the sweetness from palatinose is perceivable, but the sweetness as a whole is light, and a good aftertaste and smooth feel can be imparted to the beverages. Furthermore, at the same time, an improvement in the flavor can be achieved by reducing the unpleasant taste and odor of soymilk. Therefore, according to the present invention, soymilk beverages, which are not too sweet, can be prepared. Furthermore, the amount of soymilk added can be increased together with a reduction in the excessive amount of the additives added to improve the flavor, such as flavorings, fruit juice, sweeteners and others, unlike the conventional methods wherein the unpleasant taste and odor of soymilk are improved by means of another strong taste or aroma.

The addition of various flavorings to the soymilk beverage according to the present invention can provide an even more excellent flavor. Such flavorings include, for example, yogurt, various berries, orange, Chinese quince, perilla, citrus, apple, mint, grape, pear, custard cream, peach, melon, banana, tropical fruit, herb, black tea, powdered green tea, coffee, cocoa, chocolate, malt and sesame seed flavorings and similar flavorings, alone or in a combination of two or more flavorings. In particular, berry, orange, grape, banana, black tea, powdered green tea, coffee, cocoa, malt and sesame seed flavorings and similar flavorings are preferred because they have a good compatibility with soymilk. The amount of flavorings added is not limited to particular one, but, in terms of the flavor, is preferably 0.05 to 0.5% by weight, in particular 0.1 to 0.3% by weight based on the soymilk beverage according to the present invention.

The soymilk composition according to the present invention can, instead of the above flavorings or additionally, comprises any other food additives, such as various sugars, emulsifiers, thickeners, sweeteners, sour agents and fruit juice. Specifically, the soymilk beverages having an excellent flavor can also be prepared with the addition of sugars, such as sucrose, isomerized sugars, glucose, fructose, trehalose, lactose, xylose and trehalulose; sugar alcohols, such as sorbitol, xylitol, erythritol, lactitol, hydrogenated palatinose, hydrogenated glucose syrup and reduced malt sugar syrup; emulsifiers, such as sucrose fatty acid esters, glycerin fatty acid esters and lecithin; thickeners or stabilizers, such as agar-agar, gelatin, carrageenan, guar gum, xanthan gum, pectins and locust bean gum; nutrient supplements, such as vitamin A, vitamin Bs, vitamin C, vitamin E and calcium, or herb extracts. Moreover, by using a combination of palatinose, which also serves as a sweetener, with other sweeteners, the light and smooth feel of the beverage can be increased compared with the individual use of said other sweeteners based on the same sweetness potency

In the specification, the meaning of the expression “light feel” is the same as that of “light mouth feel”, and “light (mouth) feel” and “smooth (mouth) feel” are, in combination, equal to “good non-lingering aftertaste” or “good aftertaste”.

In the following, the present invention will be illustrated in more detail by means of specific examples, but is not limited thereto.

### EXAMPLES

The percentages described below are by weight, unless otherwise instructed.

### Example 1

To pure soymilk (Kibun Food Chemifa Co., Ltd.) was added, based on the resulting soymilk composition, 1%, 2%, 3%, 5% or 10% of crystalline palatinose-IC (Shin Mitsui Sugar Co., Ltd.) to give test samples. Analogously to this, control samples were prepared by adding 0.4%, 0.8%, 1.2%, 2.0% or 4.0% of sucrose to said pure soymilk.

After completely dissolving the palatinose and the sucrose in the soymilk, added to the test samples and the control samples respectively, these samples were then cooled in a refrigerator before a sensory test, and the sensory test was conducted for such cooled samples.

The sensory test was conducted by eight panelists and, for a pair of the test sample and control sample having the same sweetness potency, these were compared regarding the qualities of the following evaluation items: less soybean odor, flavor, lightness in the mouth feel, non-lingering aftertaste, balance in the taste, and smooth drinkability. Namely, the test samples with 1%, 2%, 3%, 5% and 10% of palatinose added were compared with the control samples with 0.4%, 0.8%, 1.2%, 2.0% and 4.0% of sucrose added, respectively.

In the sensory test, regarding all the evaluation items, the evaluation for the control sample was standardized with a score of 3 and, then, the quality of the corresponding test sample was evaluated by eight panelists regarding which of the following scores the test sample was assigned: 1. poorer than the control; 2. slightly poorer than the control; 3. equivalent to the control; 4. slightly better than the control and 5. better than the control, followed by averaging the scores to give an actual evaluation score.

The results of said sensory test are shown in Tables 1 to 5 below.

Table 1 shows the result from the comparison of the test sample containing 1% of palatinose with the control sample containing 0.4% of sucrose. The evaluation scores for the test sample shown therein are higher than those for the control sample regarding all the evaluation items and, therefore, it is found that the use of palatinose improves the soybean odor, flavor, mouth feel, non-lingering aftertaste, balance in the taste, and drinkability and, in particular, has a high effect in the improvement of the soybean odor and non-lingering aftertaste.

TABLE 1

| | Control sample | Test sample |
|---|---|---|
| Less soybean odor | 3.0 | 3.5 |
| Flavor | 3.0 | 3.3 |
| Lightness in the mouth feel | 3.0 | 3.3 |
| Non-lingering aftertaste | 3.0 | 3.6 |
| Balance in the taste | 3.0 | 3.1 |
| Smooth drinkability | 3.0 | 3.4 |

Table 2 shows the result from the comparison of the test sample containing 2% of palatinose with the control sample containing 0.8% of sucrose. The evaluation scores for the test sample are higher than those for the control sample regarding all the evaluation items. Therefore, it is found that the use of palatinose improves the soybean odor, flavor, mouth feel, non-lingering aftertaste, balance in the taste, and drinkability and, in particular, has a high effect in the improvement of the soybean odor, mouth feel and non-lingering aftertaste.

TABLE 2

| | Control sample | Test sample |
|---|---|---|
| Less soybean odor | 3.0 | 4.1 |
| Flavor | 3.0 | 3.4 |
| Lightness in the mouth feel | 3.0 | 3.9 |
| Non-lingering aftertaste | 3.0 | 4.3 |
| Balance in the taste | 3.0 | 3.5 |
| Smooth drinkability | 3.0 | 3.6 |

Table 3 shows the result from the comparison of the test sample containing 3% of palatinose with the control sample containing 1.2% of sucrose. The evaluation scores for the test sample are higher than those for the control sample regarding all the evaluation items. Therefore, it is found that the use of palatinose improves the soybean odor, flavor, mouth-feel, non-lingering aftertaste, balance in the taste, and drinkability and, in particular, has a high effect in the improvement of the soybean odor, flavor, balance in the taste, and drinkability.

TABLE 3

| | Control sample | Test sample |
|---|---|---|
| Less soybean odor | 3.0 | 3.6 |
| Flavor | 3.0 | 3.5 |
| Lightness in the mouth feel | 3.0 | 3.1 |
| Non-lingering aftertaste | 3.0 | 3.4 |
| Balance in the taste | 3.0 | 3.6 |
| Smooth drinkability | 3.0 | 3.6 |

Table 4 shows the result from the comparison of the test sample containing 5% of palatinose with the control sample containing 2% of sucrose. The evaluation scores for the test sample are higher than or equivalent to those for the control sample regarding all the evaluation items. Therefore, it is found that the use of palatinose improves the soybean odor, lightness in the mouth feel, non-lingering aftertaste, balance in the taste, and drinkability and, in particular, has a high effect in the improvement of the soybean odor, mouth feel and non-lingering aftertaste.

TABLE 4

| | Control sample | Test sample |
|---|---|---|
| Less soybean odor | 3.0 | 3.5 |
| Flavor | 3.0 | 3.0 |
| Lightness in the mouth feel | 3.0 | 3.3 |
| Non-lingering aftertaste | 3.0 | 3.3 |
| Balance in the taste | 3.0 | 3.1 |
| Smooth drinkability | 3.0 | 3.1 |

Table 5 shows the result from the comparison of the test sample containing 10% of palatinose with the control sample containing 4% of sucrose. The evaluation scores for the test sample are higher than those for the control sample regarding all the evaluation items. Therefore, it is found that the use of palatinose improves the beverage in all the aspects, i.e., the soybean odor, flavor, mouth feel, non-lingering aftertaste, balance in the taste, and drinkability and, in particular, has a high effect in the improvement of the soybean odor and flavor.

TABLE 5

| | Control sample | Test sample |
|---|---|---|
| Less soybean odor | 3.0 | 3.5 |
| Flavor | 3.0 | 3.5 |
| Lightness in the mouth feel | 3.0 | 3.4 |
| Non-lingering aftertaste | 3.0 | 3.3 |
| Balance in the taste | 3.0 | 3.4 |
| Smooth drinkability | 3.0 | 3.3 |

As is clear from the above results, the use of palatinose in soymilk can provide prepared soymilks and soymilk beverages wherein the unpleasant taste and odor characteristic of soymilk are improved and, further, the light and smooth mouth feels are provided, thus leading to a good aftertaste.

### Example 2

To pure soymilk (Kibun Food Chemifa Co., Ltd.) was added 4% of sucrose and 0.25% of an instant coffee (Trade name: Nescafe Gold Blend, Supplier: Nestle Japan Co., Ltd.), relative to the resulting soymilk composition in each case, giving control samples. Analogously to this, test samples were prepared by adding 2.8% of sucrose, 3% of crystalline palatinose-IC (Shin Mitsui Sugar Co., Ltd.) and 0.25% of said instant coffee to said pure soymilk. These control samples and test samples were prepared such that soymilk beverages having the same sweetness potency were obtained.

After sufficiently mixing and dissolving the respective ingredients in the soymilk, incorporated into the control and test samples, respectively, these samples were cooled in a refrigerator before a sensory test and the sensory test was then conducted on these cooled samples.

The sensory test was conducted as described in Example 1. The evaluation scores for the test samples shown in Table 6 are higher than or equivalent to those for the control samples regarding all the evaluation items. It is thus found that the combination of sucrose with palatinose improves the soybean odor, lightness in the mouth feel, non-lingering aftertaste, balance in the taste, and drinkability and, in particular, has a high effect in the improvement of the soybean odor, lightness in the mouth feel, and non-lingering aftertaste.

As is clear from the above results, also in the case of soymilk beverages having a relatively strong sweetness potency and also of the use of sucrose and palatinose in combination, the use of palatinose in soymilk improves the unpleasant taste and odor characteristic of soymilk and, further, can provide a prepared soymilk and soymilk beverage excellent in the aftertaste having light and smooth mouth feels.

TABLE 6

| | Control sample | Test sample |
|---|---|---|
| Less soybean odor | 3.0 | 3.3 |
| Flavor | 3.0 | 3.0 |
| Lightness in the mouth feel | 3.0 | 3.4 |
| Non-lingering aftertaste | 3.0 | 3.5 |
| Balance in the taste | 3.0 | 3.1 |
| Smooth drinkability | 3.0 | 3.1 |

The above clearly shows that, according to the present invention, through the addition of palatinose to pure soymilk or prepared soymilks, it is possible to obtain prepared soymilks wherein the soybean odor, raw smell and acrid taste characteristic of soymilk are reduced and, further, the flavor is also improved. Furthermore, according to the present invention, also in the case of soymilk beverages to which relatively high amounts of flavorings, fruit juice and other additives are added, the use of palatinose can impart excellent light and smooth mouth feels to the beverages and, thus, provide soymilk beverages having a good aftertaste, compared with, based on an equivalent sweetness potency, those corresponding soymilk compositions which contain a sweetener other than palatinose.

We claim:

1. Prepared soymilks or soymilk beverages with an improved flavor provided by the addition of palatinose.

2. Prepared soymilks or soymilk beverages as claimed in claim 1, wherein 0.5 to 15% by weight of palatinose is added based on the finished palatinose-containing prepared soymilks or soymilk beverages.

3. Prepared soymilks or soymilk beverages as claimed in claim 2, wherein 0.5 to 10% by weight of palatinose is added based on the finished palatinose-containing prepared soymilks or soymilk beverages.

4. Prepared soymilks or soymilk beverages as claimed in any one of claims 1 to 3, wherein 0.05 to 0.5% by weight of flavorings is added based on the finished palatinose-containing prepared soymilks or soymilk beverages.

5. Prepared soymilks or soymilk beverages as claimed in claim 4, wherein 0.1 to 0.3% by weight of flavorings is added based on the finished palatinose-containing prepared soymilks or soymilk beverages.

6. Prepared soymilks or soymilk beverages as claimed in claim 4 or 5, wherein the flavorings are selected from the group consisting of berry, orange, grape, coffee, banana, black tea, powdered green tea, cocoa, malt, sesame seed flavorings and similar flavorings.

7. Prepared soymilks or soymilk beverages as claimed in any one of claims 1 to 6, wherein one or more additives selected from sugars, emulsifiers, thickeners, sweeteners, sour agents and fruit juice are added.
